(19) United States
(12) Patent Application Publication
(10) Pub. No.: US 2026/0112768 A1
(43) Pub. Date: Apr. 23, 2026

(54) BATTERY PACK FOR VEHICLE

(71) Applicants: Hyundai Motor Company, Seoul (KR); Kia Corporation, Seoul (KR)

(72) Inventors: Min Je Jo, Hwaseong (KR); Jae Hyeon Ju, Hwaseong (KR); Kyu Bin Chung, Hwaseong (KR); Hwan Noh, Hwaseong (KR); Hyun Wook Jeon, Hwaseong (KR); Hyeon Su Jin, Hwaseong (KR); Min Sik Bang, Hwaseong (KR)

(21) Appl. No.: 19/072,000

(22) Filed: Mar. 6, 2025

(30) Foreign Application Priority Data
Oct. 17, 2024 (KR) 10-2024-0142239

(51) Int. Cl. H01M 50/383; B60L 50/64; H01M 10/613; H01M 10/625; H01M 10/6554; H01M 10/658; H01M 50/242; H01M 50/249; H01M 50/289

(52) U.S. Cl. CPC H01M 50/383; H01M 10/613; H01M 10/625; H01M 10/6554; H01M 10/658; H01M 50/242; H01M 50/249; H01M 50/289; B60L 50/64; H01M 2220/20

(57) ABSTRACT

A battery pack for a vehicle includes a cooling plate, a battery module configured to be attached to the cooling plate, a lower casing surrounding at least a portion of the battery module, and a plurality of shoulder supports between the battery module and the lower casing and configured to inhibit or prevent sagging of the battery module.

### CROSS-REFERENCE TO RELATED APPLICATION

The present application under 35 U.S.C. § 119(a) the benefit of Korean Patent Application No. 10-2024-0142239, filed on Oct. 17, 2024, the entire contents of which are incorporated by reference herein.

### BACKGROUND

### (a) Technical Field

The present disclosure relates to a battery pack mounted in a vehicle, more particularly, to the battery pack including structural elements for preventing sagging of a battery module.

### (b) Description of the Related Art

A battery is mounted in a hybrid vehicle, an electric vehicle, and the like to supply electric power required to operate the vehicle.

In general, the battery is mounted in the form of a battery pack in the vehicle. A plurality of battery modules is accommodated in the battery pack, and the battery module includes a plurality of battery cells.

The battery pack includes components such as a battery casing, the plurality of battery modules accommodated in the battery casing, a battery management assembly (BMA), and a power relay assembly (PRA).

The foregoing explained as the background is intended merely to aid in the understanding of the background of the present disclosure, and is not intended to mean that the present disclosure falls within the purview of the related art that is already known to those skilled in the art.

### SUMMARY

The present disclosure is proposed to solve these problems and aims to provide a battery pack for a vehicle that is capable of preventing or inhibiting sagging of a battery module mounted to be tightly attached in an upward direction, providing structural stability of the battery module, assisting in ensuring structural rigidity of the battery pack, effectively suppressing propagation of flame caused by thermal runaway, and effectively protecting the battery module from an impact applied from a lower side of the battery pack.

Technical problems to be solved by the present disclosure are not limited to the above-mentioned technical problems, and other technical problems, which are not mentioned above, may be clearly understood from the following descriptions by those skilled in the art to which the present disclosure pertains. In one aspect, a battery pack for a vehicle is provided that comprises: a) a cooling plate; b) a battery module configured to be associated with (e.g., attached) to the cooling plate; c) a lower casing surrounding at least a portion of the battery module; and d) a plurality of shoulder supports positioned between the battery module and the lower casing and configured to inhibit or prevent sagging of the battery.

In a further aspect, the present disclosure provides a battery pack for a vehicle, the battery pack including: a cooling plate; a battery module configured to be attached to for example a lower side of the cooling plate; a lower casing installed to surround at least a portion of (e.g., a lower side of) the battery module; and a plurality of shoulder supports installed in a space between the battery module and the lower casing and configured to prevent or inhibit sagging of the battery module.

The battery module may be configured such that a plurality of battery cells overlap one another in a linear configuration, and the shoulder support may be installed to extend in a cell overlap direction that is a direction in which the battery cells of the battery module overlap one another.

The shoulder supports may be disposed to be spaced apart from one another in a direction perpendicular to the cell overlap direction from a center of the battery module.

A space between the shoulder supports disposed below the battery module and spaced apart from one another may communicate with a venting valve of the battery pack.

A cushioning pad may be provided on at least any one of an upper surface of the shoulder support facing the battery module and a lower surface of the shoulder support the lower casing.

The shoulder support may have a buffer groove recessed upward in a portion facing the lower casing.

Thermal insulators may be provided to surround two opposite surfaces of the shoulder support.

The shoulder support may be configured as a straight member having a quadrangular cross-section in which at least one buffer groove is recessed upward in a lower surface thereof.

A cushioning pad may be provided on at least one of upper or lower surfaces of the shoulder support.

Thermal insulators may be respectively provided on two opposite surfaces of the shoulder support and surround an entire lateral surface of the shoulder support.

The battery module may be provided as a plurality of battery modules disposed above the lower casing in a planar layout, and at least two or more of the shoulder supports may be disposed below each of the battery modules.

The battery module may be installed to be attached to the cooling plate in a state in which a gap filler is interposed between the battery module and the cooling plate, and the cooling plate may be positioned below a vehicle body panel.

A vehicle (e.g., an electric vehicle) may include the battery pack.

In addition, in order to achieve the above-mentioned object, the present disclosure provides a battery pack for a vehicle, the battery pack including: a battery module configured such that a plurality of battery cells overlap one another in a linear configuration; a lower casing provided to surround at least a portion of (e.g., a lower side of) the battery module; and a plurality of shoulder supports provided below the battery module and configured to define a space between the battery module and the lower casing and define a part of the space as a discharge passageway for a venting gas.

The shoulder support may be configured as a straight member elongated in a cell overlap direction, which is a direction in which the battery cells of the battery module overlap one another, in order to prevent the battery cells of the battery module from sagging downward.

The shoulder support may be configured as a straight member having a quadrangular cross-section in which a plurality of buffer grooves are recessed upward in a lower surface thereof.

A cushioning pad may be provided on at least one of upper or lower surfaces of the shoulder support.

At least any one of two opposite surfaces of the shoulder support may be surrounded by a thermal insulator.

A plurality of battery modules may be provided above the lower casing and disposed in parallel with one another in a direction perpendicular to the cell overlap direction, the plurality of shoulder supports may be disposed for each of the battery modules, and among spaces provided between the battery module and the lower casing and defined by the shoulder supports, a space, which is independently formed below each of the battery modules without being shared with an adjacent battery module, may communicate with a venting valve of the battery pack.

According to the battery pack for a vehicle of the present disclosure, it is possible to ensure the structural stability of the battery module by preventing sagging of the battery module mounted to be tightly attached in the upward direction.

In addition, it is possible to assist in ensuring the structural rigidity of the battery pack, effectively suppress propagation of flame caused by thermal runaway, and effectively protect the battery module from an impact applied from the lower side of the battery pack.

The effects obtained by the present disclosure are not limited to the aforementioned effects, and other effects, which are not mentioned above, will be clearly understood by those skilled in the art from the following description.

### BRIEF DESCRIPTION OF THE DRAWINGS

FIG. 1 is a perspective view illustrating an embodiment of a battery pack according to the present disclosure.

FIG. 2 is an exploded perspective view of the battery pack in FIG. 1.

FIG. 3 is a view illustrating only battery modules in FIG. 2.

FIG. 4 is a view illustrating one of the battery modules in FIG. 3.

FIG. 5 is a cross-sectional view taken along line V-V in FIG. 1.

FIG. 6 is a cross-sectional detailed view of a shoulder support in FIG. 5.

FIGS. 7 to 9 are views illustrating arrangement examples of the shoulder supports below the battery module.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In the description of the embodiments disclosed in the present specification, the specific descriptions of publicly known related technologies will be omitted when it is determined that the specific descriptions may obscure the subject matter of the embodiments disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In any configuration among the configurations disclosed in the present specification, any number of components or various components may be included in the present disclosure disclosed in the present specification. The components may include any combination of the features disclosed in the present specification and be arranged in any configuration among various configurations disclosed in the present specification. The concepts related to the use and operations of the components of the present disclosure, as well as the structure and arrangement of the components of the present disclosure, may be applied not only to particular embodiments discussed in the present specification but also to any number of embodiments in any combination. The embodiments including various features of various arrangements will be described below with reference to the drawings.

Hereinafter, various embodiments disclosed in the present specification will be described in detail with reference to the accompanying drawings. The same or similar constituent elements are assigned with the same reference numerals regardless of reference numerals, and the repetitive description thereof will be omitted.

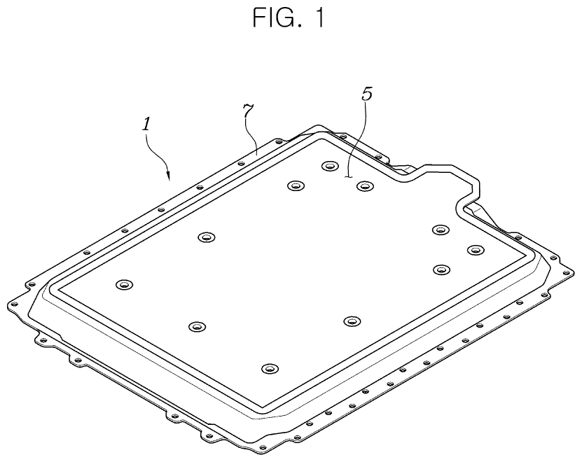

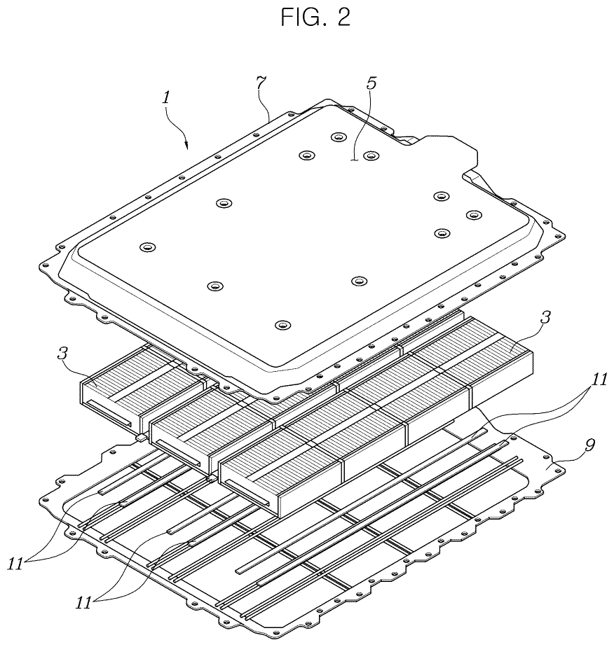

FIG. 1 is a perspective view illustrating an embodiment of a battery pack 1 according to the present disclosure, and FIG. 2 is an exploded perspective view of the battery pack 1 in FIG. 1. A cooling plate 5 and an upper casing 7 are provided above a battery module 3, a lower casing 9 is provided below the battery module 3, and a plurality of shoulder supports 11 is provided between the battery module 3 and the lower casing 9.

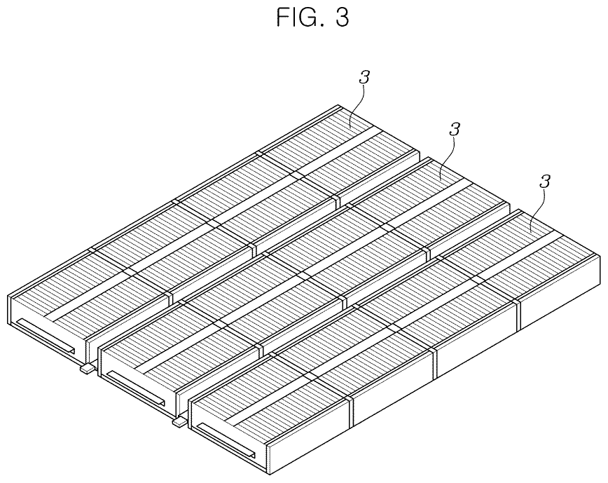

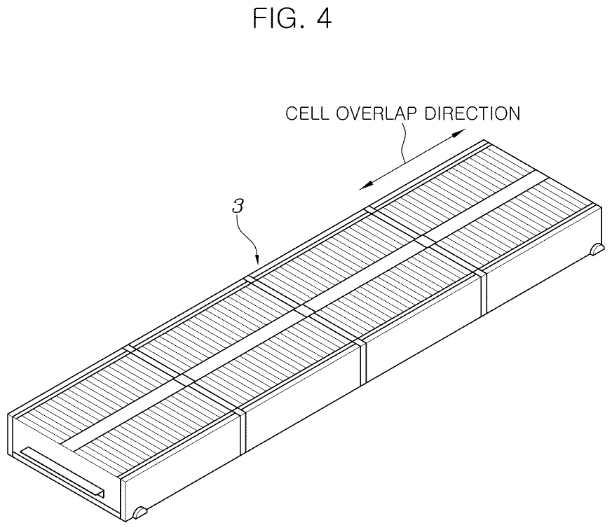

FIG. 3 is a view illustrating only the battery modules 3 in FIG. 2, and FIG. 4 is a view illustrating only one of the battery modules 3 in FIG. 3. The battery module 3 is configured in a state in which a plurality of battery cells overlap one another in one direction.

That is, one battery module 3 is configured as the plurality of battery cells having thin plate shapes overlap one another in a cell overlap direction illustrated in FIG. 4.

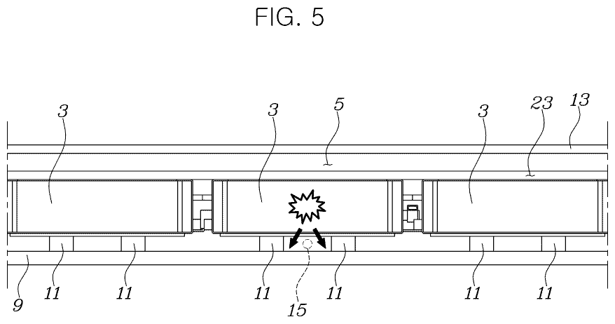

FIG. 5 is a cross-sectional view taken along line V-V in FIG. 1. The battery pack 1 may be mounted at a lower side of a vehicle body, a vehicle body panel 13 may be positioned above the cooling plate 5, and the lower casing 9 and the upper casing 7 may be coupled to the vehicle body.

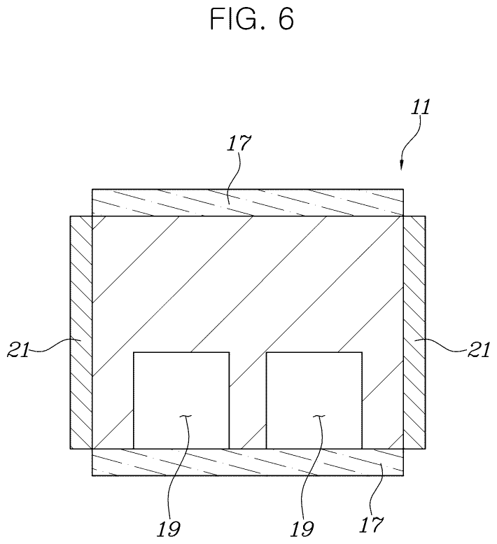

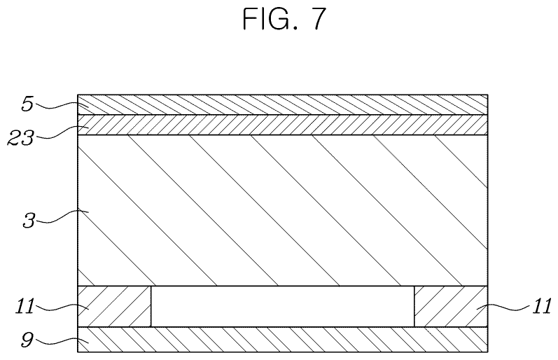

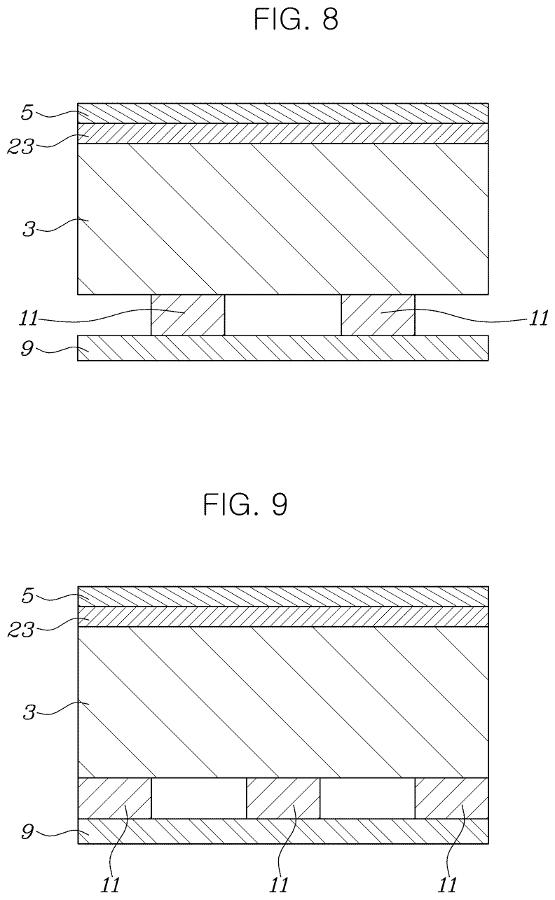

FIG. 6 is a cross-sectional detailed view illustrating one embodiment of the shoulder support 11 in FIG. 5, and FIGS. 7 to 9 are views illustrating arrangement examples of the shoulder supports 11 below the battery module 3.

That is, FIGS. 7 to 9 illustrate some of various examples in which the shoulder support 11 may be installed on one battery module 3.

With reference to FIGS. 1 to 9, an embodiment of a battery pack 1 for a vehicle of the present disclosure includes the cooling plate 5, the battery module 3 configured to be tightly attached to a lower side of the cooling plate 5, the lower casing 9 installed to surround a lower side of the battery module 3, and the plurality of shoulder supports 11 installed in a space between the battery module 3 and the lower casing 9 and configured to prevent sagging of the battery module 3.

That is, in the battery pack 1 of the present disclosure, the plurality of shoulder supports 11 may be installed between the battery module 3 and the lower casing 9 and prevent sagging of the battery module 3.

The battery module 3 is configured such that a plurality of battery cells overlap one another straight. The shoulder support 11 is installed to be elongated in the cell overlap direction that is the direction in which the battery cells of the battery module 3 overlap one another.

Therefore, the shoulder supports 11 effectively prevent a situation in which some of the battery cells constituting the battery module 3 have sagged because the plurality of battery cells constituting the battery module 3 overlap one another in the cell overlap direction.

The shoulder supports 11 are disposed to be spaced apart from one another in a direction perpendicular to the cell overlap direction from a center of the battery module 3.

That is, as illustrated in FIGS. 7 to 9, at least two shoulder supports 11 are disposed below each of the battery modules 3. The two shoulder supports 11 are disposed to be spaced apart from each other from the center of the battery module 3 toward two opposite sides of the battery module 3, such that a space is formed between the two shoulder supports 11.

For reference, in FIG. 9, the two shoulder supports 11 are disposed to be spaced apart from each other from the center of the battery module 3 toward the two opposite sides of the battery module 3, and one shoulder support 11 is further provided at the center of the battery module 3.

The space between the shoulder supports 11 disposed below the battery module 3 and spaced apart from one another may communicate with a venting valve 15 of the battery pack 1.

For example, as illustrated in FIG. 5, when a fire occurs in any one battery cell and flame and venting gas are discharged, the flame and venting gas are most highly likely to be discharged into the space between the battery module 3 and the lower casing 9 because of the structure of the battery pack 1. In this case, the discharged flame and venting gas are blocked by the shoulder supports 11, which are disposed at two opposite sides below the battery module 3 and spaced apart from one another, without propagating to another adjacent battery module 3, such that the thermal runaway of the battery pack 1 may be suppressed or reduced.

In addition, the venting gas discharged into the space between the shoulder supports 11 disposed below the battery module 3 and spaced apart from one another is smoothly discharged to the outside of the battery pack 1 through the venting valve 15 that communicates with the space, which may significantly contribute to suppressing the thermal runaway of the battery pack 1.

For reference, the venting valve 15 is illustrated in FIG. 5 to conceptually illustrate that the venting valve 15 is installed to be connected to the space between the two shoulder supports 11, instead of illustrating that the venting valve 15 is actually present at the corresponding position.

A cushioning pad 17 may be provided on at least any one of an upper surface of the shoulder support 11 opposite to the battery module 3 and a lower surface of the shoulder support 11 opposite to the lower casing.

The cushioning pad 17 provided on the upper surface of the shoulder support 11 opposite to the battery module 3 suppresses direct physical contact between the battery module 3 and the shoulder support 11 and the transmission of impact, thereby protecting the battery cells that constitute the battery module 3.

In addition, the cushioning pad 17 provided on the lower surface of the shoulder support 11 opposite to the lower casing serves to remove a clearance between the shoulder support 11 and the lower casing 9 and mitigate an impact force applied from the lower side of the lower casing 9, thereby assisting in preventing the occurrence of noise while the vehicle travels and preventing an impact, which is applied from the lower side of the vehicle, from being transmitted to the battery module 3.

The shoulder support 11 may have a buffer groove 19 recessed upward in a portion directed toward the lower casing 9.

Specifically, in the present embodiment, the shoulder support 11 is configured as a straight member having a quadrangular cross-section in which at least one buffer groove 19 is recessed upward in a lower surface.

Therefore, the shoulder support 11 absorbs an impact force applied from the lower side of the lower casing 9 while the lower portion thereof is deformed first before the upper portion thereof is deformed, thereby obtaining an effect of preventing the impact from being transmitted directly to the battery module 3, if possible.

Meanwhile, thermal insulators 21 may be provided on the shoulder support 11 and surround two opposite surfaces of the shoulder support 11.

This is to protect the shoulder support 11 from the flame and venting gas discharged from the battery cell, thereby consistently ensuring and maintaining the function of blocking the propagation of flame to the adjacent battery module 3 and the function of smoothly discharging the venting gas.

Therefore, the thermal insulator 21 may be provided to surround the entire lateral surface of the shoulder support 11. Mica or the like may be used for the thermal insulator 21.

In the present embodiment, the plurality of battery modules 3 is disposed above the lower casing 9 in a plan view. At least two or more shoulder supports 11 are disposed below each of the battery modules 3.

In addition, the battery module 3 is installed to be tightly attached to the cooling plate 5 in a state in which a gap filler 23 is interposed between the battery module 3 and the cooling plate 5, such that the battery module 3 is effectively cooled by the cooling plate 5, and the cooling plate 5 is positioned below the vehicle body panel 13.

The battery pack 1 of the present disclosure may also be expressed as follows.

That is, the embodiment of the battery pack 1 for a vehicle of the present disclosure includes the battery module 3 configured such that the plurality of battery cells overlap one another straight, the lower casing 9 provided to surround the lower side of the battery module 3, and the plurality of shoulder supports 11 provided below the battery module 3 and configured to define the space between the battery module 3 and the lower casing 9 and define a part of the space as a discharge passageway for the venting gas.

In order to prevent the battery cells of the battery module 3 from sagging downward, the shoulder support 11 is configured as a straight member elongated in the cell overlap direction that is the direction in which the battery cells of the battery module 3 overlap one another.

The shoulder support 11 is configured as a straight member having a quadrangular cross-section in which the plurality of buffer grooves 19 is recessed upward in the lower surface.

The cushioning pad 17 is provided on at least one of the upper or lower surfaces of the shoulder support 11.

At least any one of the two opposite surfaces of the shoulder support 11 is surrounded by the thermal insulator 21.

The plurality of battery modules 3 are provided above the lower casing 9 and disposed in parallel with one another in the direction perpendicular to the cell overlap direction, and the plurality of shoulder supports 11 is disposed for each of the battery modules 3. Among the spaces provided between the battery module 3 and the lower casing 9 and defined by the shoulder supports 11, the space, which is independently formed below the battery module 3 without being shared with the adjacent battery module 3, communicates with the venting valve 15 of the battery pack 1.

While the specific embodiments of the present disclosure have been illustrated and described, it will be obvious to those skilled in the art that the present disclosure may be variously modified and changed without departing from the technical spirit of the present disclosure defined in the appended claims.

What is claimed is:

1. A battery pack for a vehicle, the battery pack comprising:
a cooling plate;
a battery module configured to be associated with the cooling plate;
a lower casing surrounding at least a portion of the battery module; and
a plurality of shoulder supports positioned between the battery module and the lower casing and configured to inhibit sagging of the battery module.

2. The battery pack of claim 1, wherein the battery module is configured such that a plurality of battery cells overlap one another in a linear configuration, and
wherein the shoulder support is installed to extend in a cell overlap direction that is a direction in which the battery cells of the battery module overlap one another.

3. The battery pack of claim 2, wherein the shoulder supports are disposed to be spaced apart from one another in a direction perpendicular to the cell overlap direction from a center of the battery module.

4. The battery pack of claim 3, wherein a space between the shoulder supports disposed below the battery module and spaced apart from one another communicates with a venting valve of the battery pack.

5. The battery pack of claim 2, wherein a cushioning pad is provided on at least any one of an upper surface of the shoulder support facing the battery module and a lower surface of the shoulder support facing the lower casing.

6. The battery pack of claim 2, wherein the shoulder support has a buffer groove recessed upward in a portion facing the lower casing.

7. The battery pack of claim 2, the battery pack further comprises thermal insulators provided to surround two opposite surfaces of the shoulder support.

8. The battery pack of claim 2, wherein the shoulder support is configured as a straight member having a quadrangular cross-section in which at least one buffer groove is recessed upward in a lower surface thereof.

9. The battery pack of claim 8, wherein a cushioning pad is provided on at least one of upper or lower surfaces of the shoulder support.

10. The battery pack of claim 9, further comprising thermal insulators respectively provided on two opposite surfaces of the shoulder support and surround an entire lateral surface of the shoulder support.

11. The battery pack of claim 1, wherein the battery module is provided as a plurality of battery modules disposed above the lower casing in a planar layout, and at least two or more of the shoulder supports are disposed below each of the battery modules.

12. The battery pack of claim 1, wherein the battery module is installed to be attached to the cooling plate in a state in which a gap filler is interposed between the battery module and the cooling plate, and
wherein the cooling plate is positioned below a vehicle body panel.

13. The battery pack of claim 1, wherein the lower casing is installed to surround a lower side of the battery module.

14. A vehicle comprising the battery pack of claim 1.

15. A battery pack for a vehicle, the battery pack comprising:
a battery module configured such that a plurality of battery cells overlap one another in a linear configuration;
a lower casing provided to surround at least a portion of the battery module; and
a plurality of shoulder supports provided below the battery module and configured to define a space between the battery module and the lower casing and define a part of the space as a discharge passageway for a venting gas.

16. The battery pack of claim 15, wherein the shoulder support is configured as a straight member elongated in a cell overlap direction, which is a direction in which the battery cells of the battery module overlap one another, in order to prevent the battery cells of the battery module from sagging downward.

17. The battery pack of claim 16, wherein the shoulder support is configured as a straight member having a quadrangular cross-section in which a plurality of buffer grooves are recessed upward in a lower surface thereof.

18. The battery pack of claim 16, wherein a cushioning pad is provided on at least one of upper or lower surfaces of the shoulder support.

19. The battery pack of claim 15, wherein at least any one of two opposite surfaces of the shoulder support is surrounded by a thermal insulator.

20. The battery pack of claim 15, wherein a plurality of battery modules are provided above the lower casing and disposed in parallel with one another in a direction perpendicular to the cell overlap direction,
wherein the plurality of shoulder supports are disposed for each of the battery modules, and
wherein among spaces provided between the battery module and the lower casing and defined by the shoulder supports, a space, which is independently formed below each of the battery modules without being shared with an adjacent battery module, communicates with a venting valve of the battery pack.
